(19) United States
(12) Patent Application Publication
(10) Pub. No.: US 2005/0194323 A1
(43) Pub. Date: Sep. 8, 2005

(54) System and method for recovering oil from a waste stream

(75) Inventors: Raymond R. Ruth, Pearland, TX (US); Albert E. Zickefoose, Hardin, TX (US)

Correspondence Address: LOWRIE, LANDO & ANASTASI, RIVERFRONT OFFICE, ONE MAIN STREET, ELEVENTH FLOOR, CAMBRIDGE, MA, 02142, US

(73) Assignee: U.S. Filter/Scaltech, Inc., Houston, TX (US)

(21) Appl. No.: 10/793,169

(22) Filed: Mar. 4, 2004

(51) Int. Cl. C02F 1/52

(52) U.S. Cl. 210/723; 210/737; 210/205

(57) ABSTRACT

The systems and methods recover oil from an emulsified waste stream. A coagulating agent and/or a flocculating agent, or both, are added to the emulsified waste stream to accelerate separation into an aqueous stream and a thickened emulsified stream. The coagulating agent can comprise alum. The flocculating agent can comprise a cationic polymer. Separation of the thickened emulsified stream into an oil-rich component, a second aqueous component, and a solid cake can be effected by mechanical separation in a centrifuge, filter, or press.

### BACKGROUND OF THE INVENTION

1. Field of the Invention

The present invention relates to a system and method for recovering oil from a waste stream or other oil-containing streams and, in particular, to recovering oil from an emulsified stream by chemically and/or mechanically destabilizing the emulsion.

2. Discussion of Related Art

In oil refinery operations, oil-in-water emulsified streams are typically generated. These streams typically require further processing. However, because the emulsions can be difficult to break or destabilize, mechanical energy is sometimes utilized to separate the oil component from the aqueous component. For example, the emulsified streams can be processed to produce an oil-rich stream and an aqueous stream by centrifuging the emulsified stream.

Other efforts have also been undertaken. For example, Jacques, et al., in U.S. Pat. No. 4,734,205, disclose a process for breaking or resolving oil-in-water emulsions by using a low level of a water dispersible terpolymer consisting of acrylamide, acrylic acid or its salts, and alkylacrylamide or alkylacrylate or alkylmethacrylate; or copolymers consisting of acrylamide and alkylacrylamide or alkylacrylate or alkylmethacrylate alone or in combination with a cationic species. The process involves first adding a cationic polymer capable of neutralizing the surface charge on the oil droplets or converting and controlling the charge to a slightly positive value, next adding an effective amount of hydrophobically functionalized water soluble polymer, after contacting under suitable agitation conditions, allowing the emulsified oil droplets to separate under quiescent conditions into a distinct layer, and removing said layer. Alternatives to the latter step include use of gas flotation, a centrifuge or cyclone.

### SUMMARY OF THE INVENTION

In accordance with one or more embodiments, the present invention provides a system for recovering oil from an emulsified stream. The system can comprise a source of the emulsified stream, a settling tank fluidly connected to the source of the emulsified stream, a separator fluidly connected downstream of the settling tank, and a source of a coagulating agent fluidly connected upstream of the settling tank.

In accordance with one or more embodiments, the present invention provides a method of recovering oil from an emulsified stream. The method can comprise steps of destabilizing the emulsified stream, separating the destabilized emulsified stream to produce a thickened emulsified stream and an aqueous stream, and separating the thickened emulsified stream to produce a second aqueous stream, an oil-rich stream, and a solids cake.

In accordance with one or more embodiments, the present invention provides a system for recovering oil from an emulsified stream. The system can comprise a source of the emulsified stream, a settling tank fluidly connected to the source of the emulsified stream, a source of a coagulating agent fluidly connected upstream of the settling tank, and a source of a flocculating agent fluidly connected upstream of the settling tank.

In accordance with one or more embodiments, the present invention provides a method of facilitating oil recovery from an emulsified stream. The method can comprise a step of providing an oil recovery system comprising a settling tank fluidly connectable to a source of the emulsified stream, a source of a coagulating agent fluidly connectable upstream of the settling tank, and a source of a flocculating agent fluidly connectable upstream of the settling tank.

In accordance with one or more embodiments, the present invention provides a system for recovering oil. The system can comprise a source of an emulsified stream, a first separator fluidly connected to the source of the emulsified stream, a source of a coagulating agent fluidly connected upstream of the first separator, a source of a flocculating agent fluidly connected upstream of the first separator, and a second separator fluidly connected downstream of the first separator.

### BRIEF DESCRIPTION OF THE DRAWINGS

The accompanying drawings are not intended to be drawn to scale. In the drawings, each identical or nearly identical component that is illustrated in one or more figures is represented by a like numeral. For purposes of clarity, not every component may be labeled in every drawing. In the drawings:

FIG. 1 is a process flow diagram of a system for recovering oil from an emulsified stream in accordance with one or more embodiments of the present invention; and

FIG. 2 is a process flow diagram of a system for recovering oil in accordance with one or more embodiments of the present invention, as described in the Example.

### DETAILED DESCRIPTION OF THE INVENTION

This invention is not limited in its application to the details of construction and the arrangement of components set forth in the following description or illustrated in the drawings. The invention is capable of providing other embodiments and of being practiced or of being carried out in various ways. In addition, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

In accordance with one or more embodiments, the present invention provides systems and methods for recovering oil from waste streams including, for example, one or more oil refinery waste streams that can be characterized as emulsified or mixed-phase, having an aqueous component, an oily component, and, in some cases, a solids component or those having suspended matter, which, in some cases, can have like surface charges. The present invention can further be characterized as providing systems and techniques that reduce the hydraulic volume of an oil-containing stream before employing mechanical energy-utilizing unit operations to separate the oil-containing stream into an aqueous component, an oil-rich component, and, if necessary, a solids component. The present invention can also be characterized as destabilizing an emulsified stream by utilizing chemical and mechanical techniques so that a reduction of at least about 70% by volume, typically at least about 80%, can be achieved. For example, by utilizing the systems and techniques of the present invention, the hydraulic volume to be separated in a mechanical separation operation, such as a centrifuge, can be reduced from about 100 bbl of an emulsified stream to about 30 bbl of a thickened emulsion.

As used, herein, the term “destabilize” refers to any process that promotes separation of a stream into component phases. For example, destabilizing an emulsion refers to, for example, breaking an oil-in-water emulsion into a dehydrated, oil-rich component and an aqueous component. The phrases “mechanical separation” and “mechanically destabilizing” refer to utilizing unit operations that introduce mechanical energy to effect separation of a stream, typically a mixed-phase stream, into its component phases. Examples of such unit operations include, but are not limited to, centrifuges and filters, which can further utilize features and/or techniques, alone or in combination, such as separation aids like filter aids and/or impingement systems.

In accordance with one or more embodiments, the present invention provides a system for recovering oil from an emulsified stream. The system can comprise a source of the emulsified stream, a separator or separation unit operation, such as, but not limited to a settling tank, a hydrocyclone, a decanter, a dissolved air flotation unit, a dissolved nitrogen flotation unit, an induced air flotation unit, and/or an induced nitrogen flotation unit, fluidly connected to the source of the emulsified stream, a second separator fluidly connected downstream of the separation unit operation, and a source of a coagulating agent fluidly connected upstream of the separation unit operation. The system can further comprise a source of a flocculating agent fluidly connected upstream of the separation unit operation. In some cases, the source of the coagulating agent and/or the source of the flocculating agent can be fluidly connected downstream of the source of the emulsified stream and upstream of the separation unit operation. The source of the emulsified stream can comprise one or more effluent streams from one or more unit operations from one or more chemical plants including, for example, a desalter from an oil refinery.

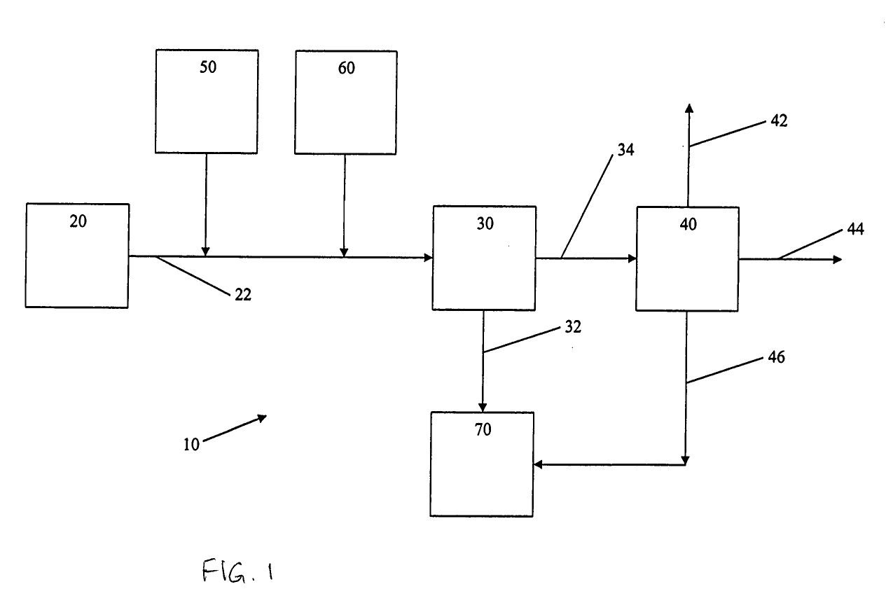

For example, as shown in the embodiment presented in FIG. 1, the oil recovery system 10 can comprise a source 20 of an emulsified stream 22 fluidly connected to one or more separation unit operations 30 or similar unit operations that, for example, provide quiescent conditions to and provide an aqueous stream 32 and a thickened, emulsified stream 34 that can be drawn therefrom. System 10 can further comprise one or more separators 40 fluidly connected, and typically disposed and arranged, to receive a thickened emulsified stream 34, to effect separation of the components of the thickened emulsified stream into an oil-rich component stream 42, a second aqueous component stream 46, and, in some cases, a solids cake 44. System 10 can further comprise a source 50 of a coagulating agent and/or a source 60 of a flocculating agent. The coagulating agent source 50 and the flocculating agent source 60 can be fluidly connected to emulsified stream 22 and separation unit operations 30. As exemplarily shown in FIG. 1, coagulating agent source 50 and flocculating agent source 60 can be fluidly connected or disposed and arranged to allow addition of one or both a coagulating agent and a flocculating agent into emulsified stream 22, typically upstream of separation unit operation 30, and, preferably, downstream of emulsified stream source 20.

The oil-rich component stream 42 can be optionally transferred to a unit operation of a chemical plant (not shown). For example, the oil-rich stream can be transferred to one or more oil refinery unit operations, which can derive or utilize hydrocarbon values associated with the oil-rich stream.

The solids cake 44 can be optionally disposed or delivered to a coker, or utilized as a fuel in one or more industrial applications, such as, but not limited to, fuel in cement processing operations (not shown).

One or all of the aqueous component streams 32 and 46 can be disposed or, as optionally illustrated in FIG. 1, further processed in, for example, a wastewater treatment unit or facility 70 that renders the stream suitable for discharge.

In accordance with one or more embodiments, the present invention provides a method of recovering oil from an emulsified stream. The method can comprise steps of destabilizing the emulsified stream, separating the destabilized emulsified stream to produce a thickened emulsified stream and an aqueous stream, and separating the thickened emulsified stream to produce a second aqueous stream, an oil-rich stream, and a solids cake. The resultant aqueous stream can be further treated in a wastewater treatment facility. The resultant oil-rich stream can be delivered to one or more unit operations in, for example, an oil refinery. The step of destabilizing the emulsified stream can comprise adding at least one of a coagulating agent and a flocculating agent. The step of separating the thickened emulsified stream can comprise mechanically destabilizing by, for example, introducing mechanical energy to accelerate or promote phase separation. The step of destabilizing the emulsified stream can comprise adding alum and a cationic polymer to the emulsified stream and heating the emulsified stream. Heating can be performed at a temperature of between about 100° F. (about 38° C.) to about 160° F. (about 71° C.). For example, the emulsified stream from, for example, source 20 can be destabilized under quiescent conditions in a separation unit operation 30, such as a settler or settling tank, in the presence of one or more coagulating agents and/or one or more flocculating agents. The method can further comprise a step of heating the emulsified stream. Heating can be performed by utilizing heat transfer unit operations such as a furnace or a heat exchanger (not shown) to effect heat transfer into emulsified stream 22 and/or by jacket or coil heating in separation unit operation 30. Separating the thickened emulsified stream 34 can be effected in a mechanical type separation operation such as, but not limited to, a centrifuge or a filter.

The coagulating agent can comprise any compound or material that promotes destabilization of oil droplets suspended in an aqueous fluid. Typically, the coagulating agent affects the charge of the suspended matter or colloidal matter, such as oil droplets and/or suspended solids, so that they can attract each other or at least do not repel each other. The coagulating agent can comprise at least one of a polyelectrolyte (large water-soluble organic molecules), cationic coagulant, alum (aluminum sulfate), polyamine, polyquaternary amine, polyquaternary ammonium chloride, melamine formaldehyde, and high, medium, or low molecular weight polymers such as poly(diallyl-dimethyl-ammonium chloride) (polyDADMAC, a low molecular weight polymer), epichlorohydrin-dimethylamine (EPI-DMA), and DADMAC, alone, or blends with alum, aluminum chlorohydrate, or polyhydroxyl-aluminum chloride, or any suitable compound or salt that promotes coagulation of the oil droplets dispersed in the aqueous phase, with or without a flocculating agent. Examples of commercially available coagulating agents include AF 6524™ polyDADMAC from Axchem Solutions, Inc., Manistee, Mich. Selection of the coagulating agent can depend on several factors including, for example, the pH of the emulsified stream, the size and size distribution of the suspended matter, the charge or nature of the effective charge of the suspended matter, and, in some cases, the type of flocculating agent utilized as well as the desired settling/separation rate.

The flocculating agent, which can be cationic, anionic, or nonionic, can comprise any compound or material that promotes agglomeration of the oil droplets dispersed, typically suspended in the aqueous fluid, into, it is believed, a larger (relative to non-agglomerated oil droplets), agglomerate that is susceptible to floating, settling, or otherwise separating from the aqueous phase. The flocculating agent thus facilitates coalescence and separation, by floating or settling of, for example, the suspended matter, e.g., oil droplets. The flocculating agent can comprise a cationic polymer such as an acrylamide polymer, a low molecular weight low charge polymer, and/or a high molecular weight high cationic charge polymer, copolymers of acrylamide and DADMAC or dimethyl-aminoethyl-methacrylate, or any suitable compound that promotes flocculation of the suspended matter, with or without the aid of a coagulating agent. Depending on, among other factors, the nature of emulsion, one or more various flocculating agents can be utilized. Selection of the flocculating agent can depend on several factors including, but not limited to, the pH of the emulsified stream, the aqueous component of the emulsified stream, and/or the suspended matter, as well as the nature of the desolubilized suspended matter, i.e., relative size and/or distribution of size, and, in some cases, the type of coagulating agent utilized and the desired settling/separation rate. Examples of commercially available flocculating agents or flocculants include AF 3910™ low molecular weight, low cationic charge polymer and AF 4880™ high molecular weight high cationic charge polymer, both available from Axchem Solutions, Inc.

The amount of coagulating agent added can vary. Preferably, the amount of coagulating agent results, in a representative sample of the emulsified stream, that results or at least promotes, breaking the emulsion, with or without any added flocculating agent, within about 30 minutes to about two hours of quiescent settling time. The amount of coagulating agent can be determined so that that less than about 500 mg/l suspended solids remains in any one of the resultant aqueous component and/or the resultant oil-rich component, within about thirty minutes to about two hours of quiescent settling time. For example, the amount of coagulating agent added results in a coagulating agent concentration, in the emulsified stream, ranging from 0 ppm to about 100 ppm.

Thus, selection of the one or more coagulating agents and the one or more flocculating agents can depend on the nature of the emulsified stream.

The coagulating agent may be added to the emulsified stream in any suitable manner that promotes dispersion of the coagulating agent in the emulsified stream. For example, the coagulating agent may be introduced into the emulsified stream in a vessel containing the emulsified stream. Adding the coagulating agent may also be effected by injection into one or more lines or conduits containing the emulsified stream. Control of the addition of the coagulating agent may be regulated as necessary to provide the desired concentration in the emulsified stream. For example, injection of the coagulating agent can be controlled by actuating a control valve or energizing/de-energizing an injection pump delivering the coagulating agent from a coagulating agent source.

The amount of flocculating agent added can vary. Preferably, the amount of flocculating agent results, in a representative sample of the emulsified stream, that results or at least promotes or facilitates coalescence of the emulsion, with or without any added coagulating agent, preferably, within about thirty minutes to about two hours of quiescent settling time. The amount of flocculating agent can be determined such that less than about 500 mg/l suspended solids remains in any one of the aqueous component and/or the oil-rich component within about 30 minutes to about two hours of quiescent settling time. For example, the amount of flocculating agent added results in a flocculating agent concentration, in the emulsified stream, ranging from 0 ppm to about 200 ppm.

The flocculating agent may be added to the emulsified stream in any suitable manner that promotes dispersion of the flocculating agent in the emulsified stream. For example, the flocculating agent may be introduced into the emulsified stream in a vessel containing the emulsified stream. Adding the flocculating agent may also be effected by injection into one or more lines or conduits containing the emulsified stream. Control of the addition of the flocculating agent may be regulated as necessary to provide the desired concentration in the emulsified stream. For example, injection of the coagulating agent can be controlled by actuating a control valve or energizing/de-energizing an injection pump delivering the flocculating agent from a flocculating source.

The flocculating agent can be added with, before, or after adding the coagulating agent. Mixing of the emulsified stream after addition of the coagulating agent, the flocculating agent, or both can be performed. Mixing can be performed by utilizing static or dynamic techniques. Mixing can be performed before or in the first separator such as the settling tank.

The separation unit operation typically facilitates separation of an aqueous phase from an oil-rich phase of a liquid volume. Thus, in accordance with one or more embodiments of the invention, the separation unit operation can comprise any device or system that effects or facilitates separation of two or more liquid phases. Examples of such system include a settling tank, a hydrocyclone, a decanter, a dissolved air flotation unit, a dissolved nitrogen flotation unit, an induced air flotation unit, and/or an induced nitrogen flotation unit.

The settling tank and/or the decanter can comprise one or more vessels constructed and arranged to provide quiescent settling conditions. In accordance with preferred embodiments of the present invention, the settling tank and/or decanter can have a reducing volume section such as a cone or frusto-conic shape, providing a tapering cross-section, which facilitates separation of component, phases of a fluid. The degree or nature of the reducing section can vary and may depend on several factors including, but not limited to, the total processing hydraulic loading, the nature of the interface between phases, and the relative contrast between phases or difficulty in determining one phase from another. In accordance with other embodiments of the invention, the settling tank and/or decanter can comprise sections that can allow or facilitate identification of the position of an interface between phases, e.g. between an oil-rich phase and an aqueous phase. For example, the settling tank and/or decanter can have two or more draw taps or outlets along a length, typical along a vertical length, thereof. The settling tank and/or decanter can further comprise one or more sightglasses that allows a visual indication of the position of the interface. The settling tank and/or decanter can further comprise features that promote quiescence and/or accelerate the development of phases. For example, the settling tank and/or decanter can have features such as baffles or impingement plates or other components arranged to reduce any turbulence typically associated with introduction of an emulsified stream into or withdrawal of one or more phases therefrom.

As described above, the emulsified stream can be heated to accelerate phase separation into a thickened emulsion phase and an aqueous phase. Heating can be performed in any suitable heat transfer unit operation such as a heat exchanger or a furnace. Heating can also be performed before or during quiescent conditions. For example, the settling tank can comprise a heating coil or a heating jacket having heating fluid flowing therein. The emulsified stream can be heated to any suitable temperature. Preferably, the emulsified stream is heated to between about 100° F. (about 38° C.) to about 160° F. (about 71° C.). However, at lower temperatures, separation may proceed but at slower rates. Likewise, at higher temperatures, separation rates may be performed but may result in degradation or decomposition of the coagulating agent or the flocculating agent, or both, which may effectively reduce the settling or separation rate.

In accordance with one or more embodiments of the invention, the thickened emulsified stream can be transferred to one or more vessels or holding tanks, which can provide components or subsystem that heat and/or cool the thickened emulsified stream, prior to, for example, separation in separator 40. The components or subsystems can heat the contents of the holding tank to a temperature between about 160° F. (about 71° C.) and about 200° F. (about 93° C.).

Separator 40 can comprise one or more mechanical separator systems. As described above, the second separator preferably separates the thickened emulsified stream into an oil-rich stream, an aqueous stream, and, in some cases, a solid cake. Thus, in accordance with one or more embodiments of the present invention, the second separator can comprise one or more devices or system that can effect or facilitate three or more phase separation of an emulsified liquid. For example, the second separator can comprise one or more centrifuge devices that accelerate the development of phase layers by increasing the effective applied gravitational force. Examples of suitable devices include three-phase centrifuges such as the model DC6™ vertical centrifuge, available from Guinnard Oil Services, Saint-Cloud, France, model 3003 horizontal centrifuge, available from Centrisys Corporation, Kenosha, Wis., or other similar vertical or horizontal centrifuges available from, for example, Alfa Laval AB, Sweden and Westfalia Separator, Inc., Northvale, N.J. In accordance with other embodiments of the invention, the second separator can comprise one or more expression systems or filtration systems that facilitate separation of a liquid from a mixed-phase or emulsified stream. The expression or filtration systems can be coupled with one or more systems that further effect separation of a resultant emulsified stream, including a thickened emulsified stream, into an oil-rich stream and an aqueous stream. Examples of suitable expression or filtration systems include, but are not limited to presses, filter presses, and belt filter presses.

A second flocculating agent stream can be added to the thickened emulsified stream to aid or facilitate separation of the thickened emulsified stream into its components. The second flocculating agent stream can comprise one or more of the flocculating agents discussed above. The amount of the second flocculating agent stream added can vary as necessary to facilitate, for example, mechanical separation of the thickened emulsified stream. For example, the amount added can vary from about 0 ppm to about 200 ppm.

In accordance with further embodiments of the present invention, a demulsifying agent can be added to the thickened emulsified stream to aid or facilitate separation of the thickened emulsified stream into its components in the second separator. The demulsifying agent can comprise one or more surfactants or dispersants that. Further, the demulsifying agent can comprise one or more compounds denominated as coagulating agents described herein. Examples of suitable surfactants include ionic or nonionic surfactants such as ethylene oxide, propylene oxide, or blends thereof, which can be commercially available from U.S. Filter/Scaltech, Inc. as, for example, SCALBREAK™ DP-102™ surfactant.

The present invention can be further understood in view of the following example, which is illustrative in nature and not to be considered as limiting the scope of the invention.

### EXAMPLE

### Oil Recovery from a Desalter Blowdown and Mudwash Effluent Stream

The following example describes a system and method utilized to recover oil from a desalter discharge stream in accordance with one or more embodiments of the invention.

Effluent streams from a desalter were accumulated. The effluent stream was comprised of one or more desalter blowdown and mudwash effluent streams and was characterized to be comprised of about 0.02 to 1 wt % solids, 0.5 to 2 wt % oil, and water, comprising the balance. Characterization was performed by retrieving about 1 liter samples. Alum was added to each sample to a concentration of about 20 ppm. AF 4880™ flocculating agent was also added to a concentration of about 30 ppm. After heating, settling and separation of the aqueous component, the aqueous content was analyzed by azeotropic distillation with toluene in accordance with ASTM D 95. The solids content was characterized by performing a solvent extraction test as described below. The balance was deduced to be the oil content.

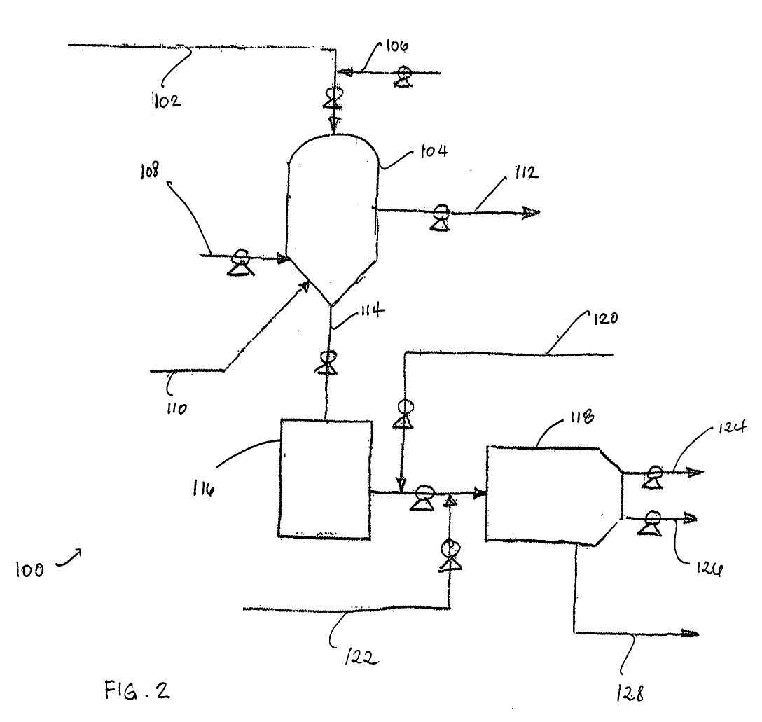

FIG. 2 shows the process flow diagram of the oil recovery system 100 utilized in this example. The emulsified stream 102 was transferred to a cone-bottomed settling tank 104 sized to contain about 130 bbl. A coagulating stream 106 was added to the emulsified stream 102 during its transfer into tank 104. The coagulating stream was comprised of alum, about 48% aluminum sulfate (Al₂(SO₄)₃.14H₂O), and was controlled to be added at a rate of about 0.001 to about 0.002 gallon per barrel of emulsified stream 102. A flocculating agent stream 108 was introduced into settling tank 104. The flocculating agent was comprised of AF 4880™ polymer and was controlled to be added at a rate of about 0.0005 to about 0.003 gallons per barrel of emulsified stream 102.

Steam 110 was circulated in a heating coil (not shown) in settling tank 102 to heat the emulsified stream. Steam was regulated to control the temperature of the contents of settling tank 102 at between about 100° F. (about 38° C.) to about 120° F. (about 49° C.). The contents of settling tank 102 was allowed to quiescently settle for about two hours. After which, a water layer and a thickened emulsified layer formed. The water layer was withdrawn from settling tank 102 as aqueous stream 112, which was transferred to a wastewater treatment unit (not shown).

About 400 bbl of the thickened emulsified layer was withdrawn from settling tank 102 as thickened, emulsified stream 114, which was transferred into a holding tank 116 and heated at a temperature between about 180° F. (about 82° C.) and about 200° F. (about 93° C.). Thickened, emulsified stream from tank 116 was processed or separated into its components in a separator 118. Separator 118 was comprised of a horizontal three-phase centrifuge. A second flocculating agent stream 120 was added to thickened, emulsified stream 116 during processing in separator 118. The second flocculating agent stream 120 was comprised of AF 4880™ polymer and was added at a rate of about 0.01 to about 0.04 gallons per barrel of thickened, emulsified stream 116. A demulsifying agent stream 122 was also added into thickened, emulsified stream 116. The demulsifying agent stream 122 was comprised of SCALBREAK™ DP-102™ surfactant, which was added at a rate of about 0.0005 to about 0.005 gallons per barrel of thickened, emulsified stream 116.

Thickened, emulsified stream 116 was separated into a second aqueous stream 124, an oil-rich stream 126 and a solids cake product 128. Second aqueous stream 124 was transferred to a wastewater treatment unit (not shown); oil-rich stream 126 was delivered to a refinery process (not shown); and solids cake product 128 was disposed.

Table 1 lists measured operating parameters of the system during several days. In Table 1, the volume processed of emulsified stream 102 from a desalter along with any additional emulsified stream (not shown), typically from an effluent stream of a wastewater treatment unit, are listed. Thus, for each day, the volume of emulsified stream processed was comprised of the desalter stream volume and any additional emulsified stream volume.

Each run was performed in accordance with the processing conditions described above and samples of the aqueous stream and the second aqueous stream were retrieved and analyzed to determine the Total Suspended Solids (TSS), in mg/l.

The Oil Free Dry Solids Content (OFDSC), in wt %, of the thickened emulsified stream introduced into the three-phase centrifuge was characterized by an extraction test as described below.

The quality of oil of the oil-rich stream discharged from the centrifuge was characterized by determining its Basic Sediment and Water (BS&W) content, in vol %, by utilizing in a centrifuge in accordance with ASTM D 96.

The results presented in Table 1 show that the system and method of the present can be utilized to recover oil from an emulsified stream and produce an oil-rich stream having low solids content and aqueous streams having TSS of less than about 500 mg/l.

The extraction test involved heating about 10 grams of the thickened emulsified stream in an oven, at about 103° to about 105° C., to vaporize water (to constant residue weight) and then dissolving the residue in about 150 ml of methylene chloride. The solution was filtered to recover substantially all the solids. The weight of the clean, oil-free solids trapped by the filter was determined after drying to vaporize substantially all solvent therefrom. The OFDSC was determined relative to the initial weight of the thickened emulsified stream.

TABLE 1

| | De- | Additional | TSS in | TSS in | OFDSC of | BS&W of |
|---|---|---|---|---|---|---|
| | salter | Emulsified | Aque- | Second | Thickened | Oil- |
| | Volume | Stream | ous | Aqueous | Emulsified | Rich |
| | Pro- | Volume | Stream | Stream | Stream | Stream |
| | cessed | Processed | 112 | 124 | 114 | 126 |
| Day | (bbl) | (bbl) | (mg/l) | (mg/l) | (wt %) | (vol %) |
| 1 | 820 | 0 | 240 | 140 | — | 0 |
| 2 | 133 | 163 | 220 | 120 | 2.48 | 0.5 |
| 3 | 409 | 121 | 40 | 240 | 9.56 | 0 |
| 4 | 595 | 0 | 120 | 230 | 3.2 | 0 |
| 5 | 666 | 0 | 190 | 240 | 1.5 | 0 |
| 6 | 640 | 0 | 50 | 290 | 1 | 0 |
| 7 | 666 | 295 | 60 | 150 | 1.5 | 0.2 |
| 8 | 640 | 95 | 70 | 260 | 0.7 | 1 |
| 9 | 986 | 268 | 40 | 340 | 2.19 | 1 |
| 10 | 173 | 352 | 60 | 240 | 3.24 | 1 |
| 11 | 1,038 | 320 | 70 | 320 | 3.11 | 0.75 |
| 12 | 320 | 732 | 60 | 180 | 3.11 | 1 |
| 13 | 1,038 | 238 | 30 | 130 | 2.4 | 1 |

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the scope of the invention. For example, although the present invention has been characterized as destabilizing an emulsified stream, from a desalter unit operation, into component streams, other sources of emulsified streams, including other unit operations or waste operations from an oil refinery as well as other operations from other chemical facilities generating a mixed-phase stream can comprise the source of the emulsified stream. Accordingly, the foregoing description and drawings are by way of example only.

1. A system for recovering oil from an emulsified stream comprising:
a source of the emulsified stream;
a settling tank fluidly connected to the source of the emulsified stream;
a separator fluidly connected downstream of the settling tank; and
a source of a coagulating agent fluidly connected upstream of the settling tank.

2. The system of claim 1, further comprising a source of a flocculating agent fluidly connected upstream of the settling tank.

3. The system of claim 1, wherein the source of the emulsified stream comprises an effluent stream from a desalter.

4. A method of recovering oil from an emulsified stream comprising:
destabilizing the emulsified stream;
separating the destabilized emulsified stream to produce a thickened emulsified stream and an aqueous stream; and
separating the thickened emulsified stream to produce a second aqueous stream, an oil-rich stream, and a solids cake.

5. The method of claim 4, wherein destabilizing the emulsified stream comprises adding at least one of a coagulating agent and a flocculating agent.

6. The method of claim 5, wherein the coagulating agent comprises at least one of alum and a low molecular weight polymer.

7. The method of claim 5, wherein the flocculating agent comprises at least one of a cationic polymer, a low molecular weight low charge polymer, and a high molecular weight high charge polymer.

8. The method of claim 4, further comprising heating the emulsified stream.

9. The method of claim 8, wherein the emulsified stream is heated to between about 100° F. (about 38° C.) and about 160° F. (about 71° C.).

10. The method of claim 4, further comprising transferring the aqueous stream to a wastewater treatment facility.

11. The method of claim 4, further comprising transferring the oil-rich stream to a unit operation of an oil refinery facility.

12. The method of claim 4, wherein separating the thickened emulsified stream comprises mechanically destabilizing the thickened emulsified stream to produce the second aqueous stream, the oil-rich stream, and the solids cake.

13. The method of claim 4, wherein destabilizing the emulsified stream comprises adding alum and a cationic polymer to the emulsified stream and heating the emulsified stream.

14. The method of claim 13, wherein the emulsified stream is heated to between about 100° F. (about 38° C.) and about 160° F. (about 71° C.).

15. The method of claim 14, wherein separating the thickened emulsified stream comprises mechanically destabilizing the thickened emulsified stream.

16. The method of claim 15, wherein mechanically destabilizing the thickened emulsified stream comprises processing in at least one of a centrifuge, a filter press, and a belt press.

17. A system for recovering oil from an emulsified stream comprising:
a source of the emulsified stream;
a settling tank fluidly connected to the source of the emulsified stream;
a source of a coagulating agent fluidly connected upstream of the settling tank; and
a source of a flocculating agent fluidly connected upstream of the settling tank.

18. The system of claim 17, further comprising a separator fluidly connected downstream of the settling tank.

19. A method of facilitating oil recovery from an emulsified stream comprising providing an oil recovery system comprising a settling tank fluidly connectable to a source of the emulsified stream, a source of a coagulating agent fluidly connectable upstream of the settling tank, and a source of a flocculating agent fluidly connectable upstream of the settling tank.

20. The method of claim 19, wherein the oil recovery system further comprises a mechanical separator fluidly connectable downstream of the settling tank.

21. A system for recovering oil comprising:
a source of an emulsified stream;
a first separator fluidly connected to the source of the emulsified stream;
a source of a coagulating agent fluidly connected upstream of the first separator;
a source of a flocculating agent fluidly connected upstream of the first separator; and
a second separator fluidly connected downstream of the first separator.

22. The system of claim 21, wherein the first separator comprises at least one unit operation selected from the group consisting of a settling tank, a hydrocyclone, a decanter, a dissolved air flotation device, an induced air flotation device, a dissolved nitrogen flotation device, and an induced nitrogen flotation device.

23. The system of claim 21, wherein the second separator comprises at least one unit operation selected from the group consisting of a centrifuge, a filter and a press.
